(19) United States
(12) Patent Application Publication
(10) Pub. No.: US 2014/0325070 A1
(43) Pub. Date: Oct. 30, 2014

(54) USAGE CONSUMPTION FOR AN INVITEE OF A CLOUD SYSTEM

(71) Applicant: Zynga Inc., San Francisco, CA (US)

(72) Inventors: Binu Jose Philip, Fremont, CA (US); Gopal Vijayaraghavan, Bangalore (IN); Prashun Purkayastha, Bangalore (IN)

(21) Appl. No.: 14/228,566

(22) Filed: Mar. 28, 2014

(30) Foreign Application Priority Data
Apr. 24, 2013 (IN) 1208/DEL/2013

(51) Int. Cl. H04L 12/911

(52) U.S. Cl. CPC H04L 47/70
USPC 709/226

(57) ABSTRACT

A system, a storage device storing at least one program, and a computer-implemented method for tracking resource consumption by an invitee across multiple computational resources are described herein. For example, a first aggregated nodal log maintained by a first computational resource may be accessed. The first aggregated nodal log characterizes consumption from the first computational resource by the invitee. A second aggregated nodal log maintained by a second computational resource is also accessed. The second aggregated nodal log characterizes consumption from the second computational resource by the invitee. The resource consumption of resources within the cloud system by the invitee is then determined. The determination may be based on combining the first usage data of the first invitee usage record with the second usage data of the second invitee usage record. A corrective action within the cloud system is then performed based on the resource consumption.

### CLAIM OF PRIORITY

This application claims the benefit of priority under 35 U.S.C. §119 of Indian Provisional Application, Serial Number 1208/del/2013, entitled “USAGE CONSUMPTION FOR AN INVITEE OF A CLOUD SYSTEM,” and filed Apr. 24, 2013, all of which is incorporated herein by reference in its entirety for all purposes.

### TECHNICAL FIELD

The disclosed embodiments relate generally to techniques for tracking resource usage within a cloud system.

### BACKGROUND

The advent of cloud-based computing architectures has opened new possibilities for rapid and scalable deployment of web-based applications and services, such as online gaming systems, merchant stores, media outlets, and other on-line sites or services.

In general, a cloud provider deploys a set of computational resources, such as processors, operating systems, software and other components, that can be used to form a virtual resource or resources. A tenant may then interface with the cloud provider to utilize the virtual resources. For example, where a cloud provider deploys a cloud platform utilizing a platform-as-a-service (PaaS) model, the cloud platform provides a tenant an ability to deploy infrastructure tenant-created or acquired applications (e.g., as may be created using programming languages and tools supported by the provider) onto the cloud. Typically, in the PaaS model, the tenant does not manage or control the underlying cloud infrastructure including network, servers, operating systems, or storage, but has control over the deployed applications and possibly application hosting environment configurations.

In another example, the cloud platform provides a tenant with the ability to provision processing, storage, networks, and other fundamental computing resources where the tenant is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### BRIEF DESCRIPTION OF THE DRAWINGS

The embodiments disclosed in the present disclosure are illustrated by way of example, and not by way of limitation, in the figures of the accompanying drawings. Like reference numerals refer to corresponding parts throughout the drawings.

FIG. 1 is a block diagram illustrating an example of a cloud-based application service environment, according to an example embodiment.

FIG. 2 is a block diagram illustrating an implementation of the application hosting system of FIG. 1 that utilizes a cloud-based architecture to host applications from one or more tenants, according to an example embodiment.

FIG. 3 is a diagram illustrating the modules of an application container and the operation of the application container in greater detail, according to an example embodiment.

FIG. 4 is a diagram illustrating the usage monitor of FIG. 2 tracking per invitee resource consumption across various application containers running on multiple computational resources of a cloud system, according to an example embodiment.

FIG. 5 is a diagram of an aggregated cloud log generated from multiple aggregated nodal logs, according to an example embodiment.

FIG. 6 illustrates an example data flow between example components of an example system, according to an example embodiment.

FIG. 7 illustrates an example network environment, in which various example embodiments may operate.

FIG. 8 is illustrates an example computing system architecture, which may be used to implement a server or a client system, according to some embodiments.

### DESCRIPTION OF EMBODIMENTS

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures and techniques have not been shown in detail.

The embodiments described herein provide techniques for tracking resource consumption of an invitee of a cloud system. Further, some embodiments described herein provide techniques for performing one or more usage based rules to affect an invitee's ability to interact with an application hosted on the cloud system. For example, a first aggregated nodal log maintained by a first computational resource may be accessed. The first aggregated nodal log characterizes consumption from the first computational resource by the invitee. A second aggregated nodal log maintained by a second computational resource is also accessed. The second aggregated nodal log characterizes consumption from the second computational resource by the invitee. The resource consumption of resources within the cloud system by the invitee is then determined. The determination may be based on combining the first usage data of the first invitee usage record with the second usage data of the second invitee usage record. A corrective action within the cloud system is then performed based on the resource consumption.

### Example System Architecture

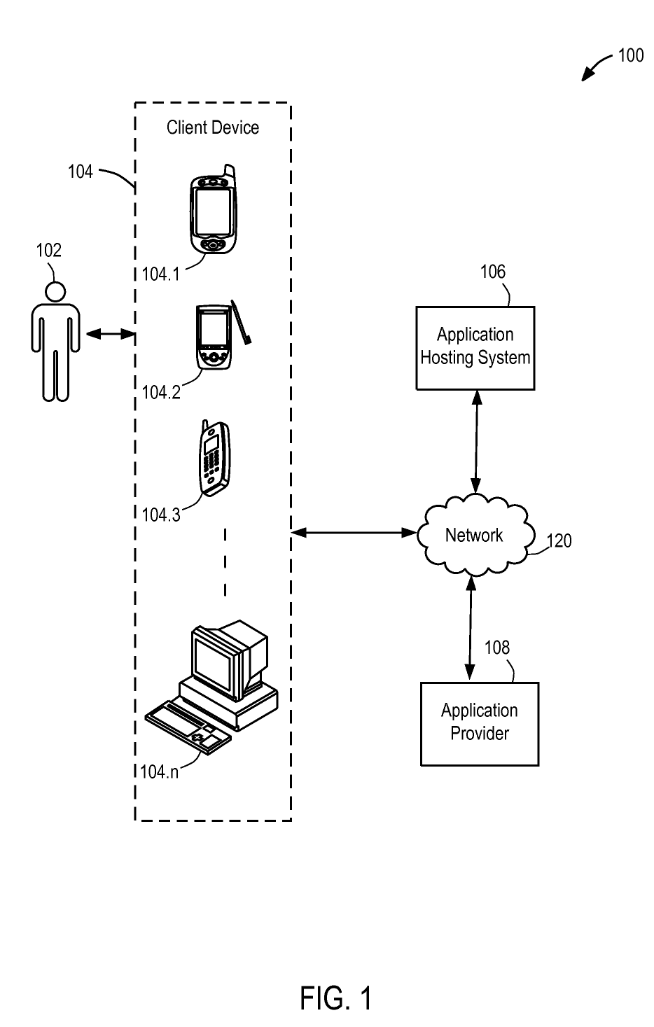

FIG. 1 is a block diagram illustrating an example of a cloud-based application service environment 100, according to an example embodiment. In some embodiments, the cloud-based application service environment 100 comprises a user 102, a client device 104, an application hosting system 106, and a network 120. The components of the cloud-based application service environment 100 may be connected directly or over the network 120, which may be any suitable network. Although FIG. 1 illustrates a particular example of the arrangement of the user 102, the client device 104, the application hosting system 106, and the network 120, any suitable arrangement or configuration of the user 102, the client device 104, the application hosting system 106, and the network 120 may be contemplated.

In various embodiments, one or more portions of the network 120 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or any other type of network, or a combination of two or more such networks.

The client device 104 may be any suitable computing device (e.g., devices 104.1-104.n), such as a smart phone 104.1, a personal digital assistant 104.2, a mobile phone 104.3, a personal computer 104.n, a laptop, a computing tablet, or any other device suitable for playing a virtual game. The client device 104 may access the application hosting system 106 directly, via the network 120, or via a third-party system, such as, for example, a social networking system. A social networking system is described in greater detail below.

The invitee 102 may be a user of an application provided by the application provider 108 but hosted by the application hosting system 106. In some embodiments, the invitee 102 accesses the application through interactions with the client device 104. The invitee 102 may have an account managed by the application provider 108 that allows access to the hosted application. In some cases, access is permitted on the basis of the invitee being assigned an invitee identifier, certificate, password, access code, or some combination thereof that certifies that the invitee 102 is authorized to access the application hosted by the application hosting system 106. It is to be appreciated that the invitee 102 is referred to as an invitee because, in some cases, the invitee 102 may have permission to access portions of the application hosted on the application hosting system 106 through access rights granted by the application provider 108. As an illustration, a game hosted on the application hosting system 106 may operate where the invitee 102 registers for a player account linked to the game developer (e.g., the application provider 108) to access game logic operating on computer systems of the application hosting system 106.

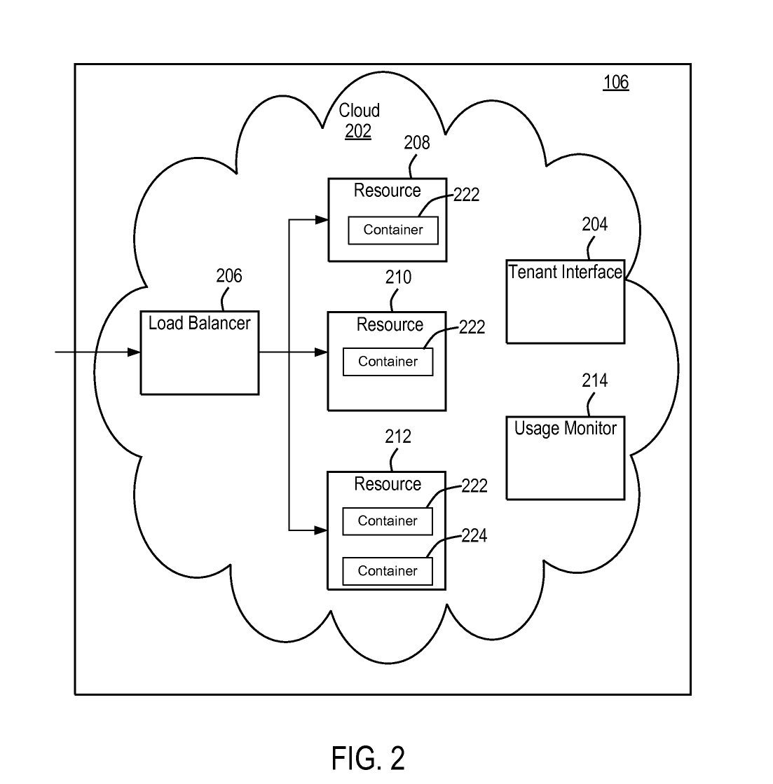

With continued reference to FIG. 1, the application hosting system 106 may include a network-addressable computing system (or systems) for hosting one or more applications. By way of example and not limitation, an online game and web services are examples of applications that may be hosted by the application hosting system 106. As is described in greater detail below, the application hosting system 106 may include multiple computational resources (e.g., physical servers, database systems, or any other computer system capable of virtualization) that may be configured to support virtualized computer systems. For example, the application provider 108 may configure some of the computational resources of the application hosting system 106 to function as web servers. Further, the application provider 108 may configure these web servers to run application code to handle web requests sent by the client device 104 operated by the invitee 102. The application hosting system 106 may be accessed by the other components of the cloud-based application service environment 100 either directly or via the network 120. The invitee 102 may use the client device 104 to access, send data to, and receive data from the application hosting system 106. Although FIG. 1 illustrates a single instance of the application hosting system 106, the application hosting system 106 may operate a plurality of distributed servers or nodes (e.g., a plurality of game servers distributed within a data center, a plurality of game servers distributed across multiple geographic locations) that provide load balancing and/or low-latency access points at various geographic locations, as may be deployed within a cloud system. Such cloud-based architectures are described with reference to FIG. 2.

The application provider 108 may be a developer of an application that runs on the application hosting system 106. By way of example and not limitation, the application provider 108 may be a game developer that configures the application hosting system 106 to host game servers that process and generate game state for the client device. It is to be appreciated that from the perspective of the application hosting system 106, the application provider 108 may be referred to as a tenant. Such is the case because the application hosting system 106 directly interacts with the application hosting system 106 to provide computational resources that support the application.

The network 120 can generally include any type of wired or wireless communication channel capable of coupling together computing nodes (e.g., the application hosting system 106). This includes, but is not limited to, a local area network (LAN), a wide area network (WAN), or a combination of networks. In some embodiments, network 120 includes the Internet.

FIG. 2 is a block diagram illustrating an implementation of the application hosting system 106 of FIG. 1 that utilizes a cloud-based architecture to host applications from one or more tenants, according to an example embodiment. For example, the application hosting system 106 may include a cloud system 202 that hosts, maintains, and runs one or more applications for the tenants of a game environment. For example, in some embodiments, the cloud system 202 includes a tenant interface 204, a load balancer 206, computer resources 208, 210, 212, and a usage monitor 216.

The tenant interface 204 may be computer-implemented module that allows a tenant (e.g., application provider 108 of FIG. 1) to deploy and manage their application running on the cloud system 202. For example, in a PaaS model, the tenant interface 204 may provide an interface for a tenant to identify an application that is to be loaded into the computer resources 208, 210, 212 of the cloud system and various quality metrics, such as an expected capacity, number of servers, and the like. In other embodiments, for example where an infrastructure-as-a-service (IaaS) model is utilized by the cloud system 202, the tenant interface 204 may allow the tenant to specify hardware requirement (e.g., processor bandwidth and memory needs) and to deploy underlying software systems, such as operating systems, database management systems, and web servers onto the computer resources 208, 210, 212.

The load balancer 206 is a computer-implemented module configured to distribute workload across the multiple computational resources 208, 210, 212. For example, as shown in FIG. 2, the load balancer 206 may route application requests (e.g., HTTP requests) received from the client 104 to one or more of the computational resources 208, 210, 212. In some cases, the load balancer 206 may route the application requests to a computational resource based on computational resource utilization of the individual computational resources, the throughput of the cloud systems, the response time of the cloud system, geographical location, the load of the cloud system 202 or the individual computational resources 208, 210, 212, or some combination thereof.

As FIG. 2 shows, the cloud system 202 of the application hosting system 106 may include computational resources 208, 210, 212 that host or execute applications provided by the tenants 102, 103. In some embodiments, the computational resources 208, 210, 212 may be physical computational resources that may be configured to function as a services of a game, such as a database, cache, webserver, and the like. For example, FIG. 2 shows that the computational resources 208, 210, 212 may include application containers 222 and 224. It is to be appreciated that the application container 222 may relate to an application deployed into the application hosting system 106 by one tenant (e.g., the application developer 108) and the application container 224 may relate to an application deployed into the application hosting system 106 by the same or different tenant. FIG. 2 also illustrates that a computational resource may run more than one container, according to example embodiments. This is shown by the computational resource 212 executing the application containers 222, 224.

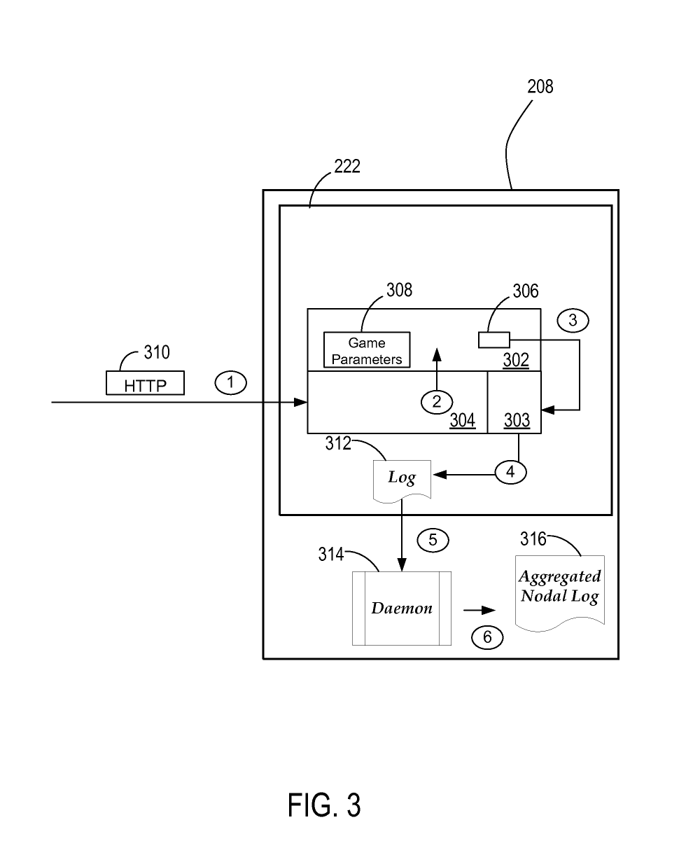

The usage monitor 214 may be a network-addressable module configured to obtain nodal logs from each of the application containers 222 and then generate an invitee computational usage report for the applications formed by the application containers. The operation of the usage monitor 214 is described in greater detail below (e.g., see FIGS. 3-5, and corresponding descriptions).

### Example Operation of Monitoring Usage Consumption

FIG. 3 is a diagram illustrating the modules of the application container 222 and the operation of the application container 222 in greater detail, according to an example embodiment. For example, the application container 222 may include application logic 302, a request handler 304, and an event logger 303. The application logic 302 may be computer-implemented module configured to perform application specific operations. For example, where the application container 222 relates to an online game, the application logic 302 may perform game related functionality, such as simulating a game action, storing game state, communicating game state, and the like. The event logger 303 may be a computer-implemented module configured to store usage records for individual request messages. In an example embodiment, the event logger 303 is part of APACHE. The request handler 304 may be a computer-implemented module configured to receive invitee initiated requests sent from the client device 104.

Operationally, the request handler 304 of the application may receive an application request 310 from the client device 104. As illustrated in FIG. 3, at operation 1, the application request 310 may be in the form of a hypertext transfer protocol (HTTP) request message. In some embodiments, the application request 310 may include an invitee identifier, such as a user identifier or certificate, and other application parameters. The application parameters may be operational parameters used by the application logic 302 to process or otherwise service the service requested by the application request 310.

At operation 2, the request handler 304 may process the application request 310. Processing the request may involve extracting the application parameters 308 from the application request 310 and sending the application parameters 308 to the application logic 302. As described above, the application parameter 308 may include an invitee identifier. In some embodiments, passing the application parameters 308 to the application logic involves instantiating an instance of the application logic to process the application parameters. Instantiating the instance of the application logic may involve activating resource consumption trackers that track resource consumption, such as time, memory usage, thread count, and the like.

At operation 3, the instance of the application logic 302 completes the service requested by the application request 310. Responsive to completing the service, the instance of the application logic 302 may execute a destructor 306. The destructor 306 may perform clean-up operations associated with resources held by the instance of the game application logic, such as release allocated memory, resources acquired (e.g., files, semaphores, locks, communication connections, files), and any other suitable computational resource used in a computing environment. Further, the destructor 306 may also log data relating to the acquisition or consumption of a resource, as may be tracked by the consumption trackers initiated at operation 2. For example, the destructor 306 may log the time, memory usage, or thread count tracked in response to the constructor executed at operation 2.

As shown in FIG. 3, logging the resources consumed by the instance may involve logging the tracked data with the event logger 303. It is to be appreciated that the tracked data may be logged in conjunction with the invitee identifier. For example, the event logger 303 may create the following application request usage record: <invitee identifier> <resource consumption>. Example of resource consumption include, by way of example and not limitation, processing time, memory usage, additional service requests (loading data not found in a cache), and the like.

At operation 4, FIG. 3 shows that the logged data may be stored in a log file 312. The log file 312 may include multiple application request usage records corresponding to other application requests, possibly initiated by the same or other invitees. Thus, in some cases, after receiving multiple application requests, the log file may have multiple application request usage records, some specifying different invitees, some specifying the same invitee.

Table 1 illustrates an example of application request usage records that the log file 312 may store.

TABLE 1

| Invitee Identifier | Usage Data |
|---|---|
| Invitee 1 | 1 second |
| Invitee 2 | 2 second |
| Invitee 1 | 1 second |
| Invitee 1 | 2 second |

With reference to Table 1, the invitee identifier is an identifier that uniquely identifies the invitee 102 identified in an application request (e.g., the application request 310). The application provider 108 may generate the invitee identifier for the invitee 102 when the invitee 102 registers with the application. The generated invitee identifier may be used in subsequent application requests sent to the game hosted by the cloud system.

With reference still to Table 1, the usage data may be a measurement of the resource consumed by the invitee for the particular application request. As shown in Table 1, the resource consumed may be processing bandwidth measured in time. Other types of resources may be measured in other embodiments, such as memory usage, thread counts, services utilized, and the like.

With reference back at FIG. 3, at operation 5, a tracking daemon 314 may be a computer-implemented module configured to consolidate the application request usage records in the log file 312 based on invitee identifiers specified by the application request usage records. That is, the tracking daemon 314 identify all the application request usage records in the log file 312 that pertain to a given invitee and then sum up the usage data for those identified application request usage records. The consolidated application request usage records for a given invitee may be referred to as an invitee usage record.

At operation, 6, the consolidated application request usage records (or, again, otherwise referred to as invitee usage records) are stored in an aggregated nodal log 316. Table 2, shown below, is an example of an aggregated nodal log that may be generated from the application request usage records shown in TABLE 1.

TABLE 2

| Invitee Identifier | Usage Data |
|---|---|
| Invitee 1 | 4 second |
| Invitee 2 | 2 second |

It is to be appreciated, then, that the aggregated nodal log 316 includes a number of invitee usage records, each invitee usage record corresponding to usage data characterizing the resources of a given computational resource that a given invitee consumed over one or more requests.

Although FIG. 3 describes the components, modules, and operations with respect to the computational resource 208, it is to be appreciated that the computational resources 210, 212 may also include similar components, modules, and operations for tracking resource consumption for an invitee. Thus, computational resource 208, 210, 212 may each maintain local copies of aggregated nodal logs that characterize the resources consumption by invitees of those computer systems.

After operation 6 of FIG. 3, the per user resource consumption has been tracked for the application container 222 deployed on the computational resource 208. However, as described above, the application container 222 may be deployed on computational resources other than the computational resource 208. Accordingly, a subsequent application request initiated by the invitee may be serviced by an instance of the application container running on a different computational resource (e.g., the application container 222 running on the computational resource 210).

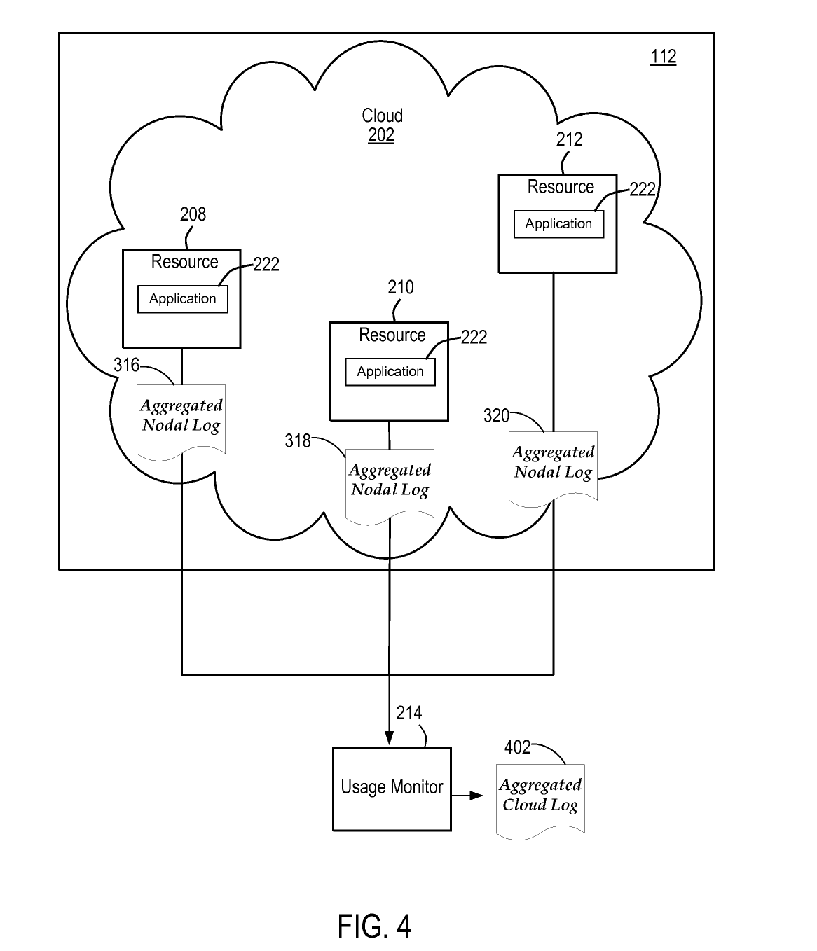

FIG. 4 is a diagram illustrating the usage monitor 214 of FIG. 2 tracking per invitee resource consumption across various application containers running on multiple computational resources of a cloud system, according to an example embodiment. For example, the computational resources 210, 212 generate aggregated nodal logs 318, 320, respectively. In an example embodiment, the computational resources 210, 212 generate the aggregated nodal logs 318, 320 similar to the method described with reference to FIG. 3.

As FIG. 4 shows, the usage monitor 214 obtains the aggregated nodal logs 316, 318, 320 from the computational resources 208, 210, 212. In an example embodiment, the usage monitor 214 may pull the aggregated nodal logs according to a determinable schedule or responsive to a trigger event, such as one of the computational resources signaling the usage monitor to pull the aggregated nodal log or a message with the aggregated nodal log. In some embodiments, the usage monitor 214 may pull the aggregated nodal logs from the computational resources 208, 210, 212 using an HTTP request.

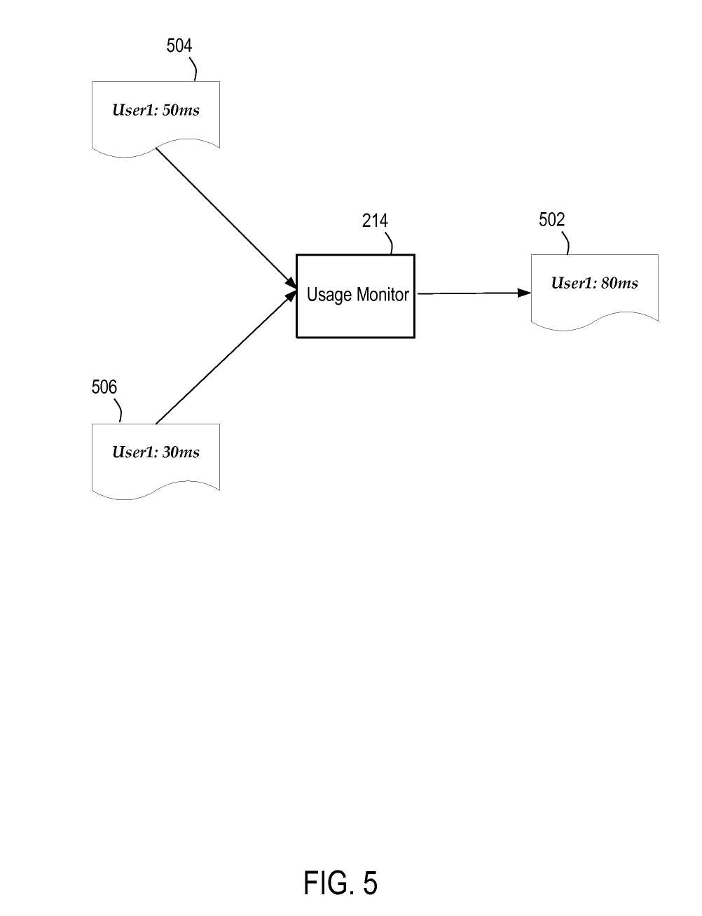

Once the usage monitor 214 obtains the aggregated nodal logs 316, 318, 320 from the computational resources 208, 210, 212, the usage monitor 214 may then generate an aggregated cloud log that indicates the computational usage for a user across the different aggregated nodal logs. For example, FIG. 5 is a diagram of an aggregated cloud log 502 generated from multiple aggregated nodal logs 504 and 506, according to an example embodiment. As described above, the aggregated nodal logs 504, 506 may be artifacts generated by different computational resources. Thus, the aggregated cloud log 502 may characterize an invitee's use of computational resource for an application even where the application may be distributed across multiple computer systems, such as may be the case in cloud-based systems. Further, example embodiments provide a framework for efficiently tracking resource usage for per user. For example, other past systems may track user usage by providing logic within the application layer for recording usage. However, tracking usage at the application layer complicates the logic code and utilizes costly (in terms of computational resource usage) function calls. In comparison, example embodiments provide tracking within the destructor of an application request message that utilizes efficient logging services provided by the request handler 304 of FIG. 3.

### Usage Rules

In some embodiments, the application provider 108 may configure the usage monitor 214 with one or more usage rules. As used herein, a usage rule may be logic or data that affects the operation of the application operating with the cloud system 202 based on data derived from the aggregated cloud log 502. For example, in one embodiment, the usage monitor 214 may include a usage rule for bot detection. The term “bot,” as used herein, may refer to an autonomous computer program that runs on the client device 104 and plays the game on behalf of the invitee 102. In an example embodiment, the bot detection usage rule may specify a rate of activity, total resource consumption, or the like. In embodiments supporting bot detection rules, the daemon 314 may collect frequency data per user, as may be measured by a number of application requests submitted by an invitee over a period of time. For example, in aggregating the multiple invitee usage records in a log file, the daemon 314 may increment a count for a number of application request usage records associated with the invitee. For example, the daemon 314 may process the request usage records illustrated in Table 1 and generate the following aggregated nodal log:

TABLE 3

| Invitee Identifier | Usage Data | Transactions |
|---|---|---|
| Invitee 1 | 4 second | 3 |
| Invitee 2 | 2 second | 1 |

As Table 3 shows, the aggregated nodal logs may include transaction counts, for each invitee usage record, that are calculated based on the number of application requests associated with an invitee in the log file. In some embodiments, the bot detection rule may represent a rate of activity based on a transaction count. Accordingly, the usage monitor 214 may detect a bot by comparing the rate of activity specified by the bot detection rule with the transaction count in the aggregated nodal log. For example, if the transaction count is greater (or greater or equal to) the rate of activity specified by the bot detection rule, the usage monitor 214 may mark the invitee as a possible bot. Otherwise, no action may be taken by the usage monitor 214. In other cases, the bot detection rule may represent a rate of activity based on resource consumption. Thus, if the resource consumption for an invitee is greater (or equal to) the resource consumption specified by the bot detection rule, the usage monitor 214 may mark the invitee as a possible bot. Otherwise, no action may be taken by the usage monitor 214.

In some cases, the usage monitor 214 may include a usage rule for fraud detection. In an example embodiment, the fraud detection usage rule may specify an application service type. An application service type may represent a type of action performed by the application responsive to a request initiated by the invitee. For example, where the application is a game, gifting (sending or receiving) game assets to other players of the game, purchasing game assets, visiting game boards associated with other players, or any other game action allowable in a game are all examples of types of actions that an invitee may initiate. In embodiments supporting fraud detection rules, the daemon 314 may generate data regarding the frequency an invitee initiates a type of application service. For example, in aggregating multiple application request usage records associated for the invitee 102, the daemon 314 may increment a count for a each type of application service performed by the computational resource in response to receiving the corresponding application request. For example, the daemon 314 may process the following application request usage records illustrated in Table 5.

TABLE 5

| Invitee Identifier | Usage Data | Service Identifier |
|---|---|---|
| Invitee 1 | 1 second | A |
| Invitee 2 | 2 second | B |
| Invitee 1 | 1 second | A |
| Invitee 1 | 2 second | B |

Responsive to the application request usage records shown in TABLE 5, the daemon 314 may generate the following aggregated nodal log shown in Table 6.

TABLE 6

| Invitee | | Application | Application |
|---|---|---|---|
| Identifier | Usage Data | Service A | Service B |
| Invitee 1 | 4 second | 2 | 1 |
| Invitee 2 | 2 second | 0 | 1 |

The Application Service A and Application Service B columns of Table 4 may represent the number of times an invitee has initiated a particular application service. A service may be represented by a service identifier, such as a unique identifier, a URI, or any other suitable identification data. The service identifier may be sent in the application request 310 sent by the client device 104. Accordingly, the service identifier may be logged by the destructor 302 at the completion of servicing the request initiated in response to the application request 310.

Accordingly, where the invitee 102 has initiated a suspicious number of services of a particular type (as may be specified by the usage rule), the usage monitor 214 may affect the invitee's ability to interact with the application hosted on the application hosting system 106. For example, if an invitee exceeds a threshold value associated with a gifting game action, the usage monitor may mark the player account associated with the invitee as suspicious. If marked as suspicious, the invitee 102 may, in some cases, be prohibited from performing the gifting game action until an administrator unmarks the player account as suspicious.

### Example Game Systems, Social Networks, and Social Graphs

As described above, the systems described herein may include, communicate, or otherwise interact with a game system. As such, a game system is now described to illustrate further embodiments. In an online multiuser game, users control player characters (PCs), a game engine controls non-player characters (NPCs), and the game engine also manages player character state and tracks states for currently active (e.g., online) users and currently inactive (e.g., offline) users. A game engine, in some embodiments, may include a documentation engine. Alternatively, the documentation engine and game engine may be embodied as separate components operated by the game network system and/or the document provision system.

A player character may have a set of attributes and a set of friends associated with the player character. As used herein, the terms “state” and “attribute” can be used interchangeably to refer to any in-game characteristic of a player character, such as location, assets, levels, condition, health, status, inventory, skill set, name, orientation, affiliation, specialty, and so on. The game engine may use a player character state to determine the outcome of a game event, sometimes also considering set variables or random variables. Generally, an outcome is more favorable to a current player character (or player characters) when the player character has a better state. For example, a healthier player character is less likely to die in a particular encounter relative to a weaker player character or non-player character.

A game event may be an outcome of an engagement, a provision of access, rights and/or benefits or the obtaining of some assets (e.g., health, money, strength, inventory, land, etc.). A game engine may determine the outcome of a game event according to game rules (e.g., “a character with less than 5 health points will be prevented from initiating an attack”), based on a character's state and possibly also interactions of other player characters and a random calculation. Moreover, an engagement may include simple tasks (e.g., cross the river, shoot at an opponent), complex tasks (e.g., win a battle, unlock a puzzle, build a factory, rob a liquor store), or other events.

In a game system according to aspects of the present disclosure, in determining the outcome of a game event in a game being played by a user (or a group of more than one users), the game engine may take into account the state of the player character (or group of PCs) that is playing, but also the state of one or more PCs of offline/inactive users who are connected to the current user (or PC, or group of PCs) through the game social graph but are not necessarily involved in the game at the time.

### Example Game Networking Systems

A virtual game may be hosted by the game networking system 108.2, which can be accessed using any suitable connection 106 with a suitable client device 104. A user may have a game account on the game networking system 108.2, wherein the game account may contain a variety of information associated with the user (e.g., the user's personal information, financial information, purchase history, player character state, game state, etc.). In some embodiments, a user may play multiple games on the game networking system 108.2, which may maintain a single game account for the user with respect to the multiple games, or multiple individual game accounts for each game with respect to the user. In some embodiments, the game networking system 108.2 may assign a unique identifier to a user 102 of a virtual game hosted on the game networking system 108.2. The game networking system 108.2 may determine that the user 102 is accessing the virtual game by reading the user's cookies, which may be appended to HTTP requests transmitted by the client device 104, and/or by the user 102 logging onto the virtual game.

In some embodiments, the user 102 accesses a virtual game and control the game's progress via the client device 104 (e.g., by inputting commands to the game at the client device 104). The client device 104 can display the game interface, receive inputs from the user 102, transmit user inputs or other events to the game engine, and receive instructions from the game engine. The game engine can be executed on any suitable system (such as, for example, the client device 104, the social networking system 108, or the game networking system 108.2). For example, the client device 104 may download client components of a virtual game, which are executed locally, while a remote game server, such as the game networking system 108.2, provides backend support for the client components and may be responsible for maintaining application data of the game, processing the inputs from the user 102, updating and/or synchronizing the game state based on the game logic and each input from the user 102, and transmitting instructions to the client device 104. As another example, when the user 102 provides an input to the game through the client device 104 (such as, for example, by typing on the keyboard or clicking the mouse of the client device 104), the client components of the game may transmit the user's input to the game networking system 108.2.

In some embodiments, the user 102 accesses particular game instances of a virtual game. A game instance is a copy of a specific game play area that is created during runtime. In some embodiments, a game instance is a discrete game play area where one or more users 102 can interact in synchronous or asynchronous play. A game instance may be, for example, a level, zone, area, region, location, virtual space, or other suitable play area. A game instance may be populated by one or more in-game objects. Each object may be defined within the game instance by one or more variables, such as, for example, position, height, width, depth, direction, time, duration, speed, color, and other suitable variables.

In some embodiments, a specific game instance may be associated with one or more specific users. A game instance is associated with a specific user when one or more game parameters of the game instance are associated with the specific user. For example, a game instance associated with a first user may be named “First User's Play Area.” This game instance may be populated with the first user's PC and one or more in-game objects associated with the first user.

In some embodiments, a game instance associated with a specific user is only accessible by that specific user. For example, a first user may access a first game instance when playing a virtual game, and this first game instance may be inaccessible to all other users. In other embodiments, a game instance associated with a specific user is accessible by one or more other users, either synchronously or asynchronously with the specific user's game play. For example, a first user may be associated with a first game instance, but the first game instance may be accessed by all first-degree friends in the first user's social network.

In some embodiments, the set of in-game actions available to a specific user is different in a game instance that is associated with this user compared to a game instance that is not associated with this user. The set of in-game actions available to a specific user in a game instance associated with this user may be a subset, superset, or independent of the set of in-game actions available to this user in a game instance that is not associated with him. For example, a first user may be associated with Blackacre Farm in an online farming game, and may be able to plant crops on Blackacre Farm. If the first user accesses a game instance associated with another user, such as Whiteacre Farm, the game engine may not allow the first user to plant crops in that game instance. However, other in-game actions may be available to the first user, such as watering or fertilizing crops on Whiteacre Farm.

In some embodiments, a game engine interfaces with a social graph. Social graphs are profiles of connections between entities (e.g., individuals, users, contacts, friends, users, player characters, non-player characters, businesses, groups, associations, concepts, etc.). These entities are considered “users” of the social graph; as such, the terms “entity” and “user” may be used interchangeably when referring to social graphs herein. A social graph can have a node for each entity and edges to represent relationships between entities. A node in a social graph can represent any entity. In some embodiments, a unique client identifier may be assigned to individual users in the social graph. This disclosure assumes that at least one entity of a social graph is a user or player character in an online multiuser game.

In some embodiments, the social graph is managed by the application provider 108 or the application hosting system. In other embodiments, the social graph is part of a social networking system managed by a third party (e.g., Facebook, Friendster, Myspace). In yet other embodiments, the invitee 102 has a social network on both the application provided by the application provider 108 and a third party social networking system, wherein the invitee 102 can have a social network on the application that is a subset, superset, or independent of the invitee's social network on the social networking system. In such combined systems, the application can maintain social graph information with edge-type attributes that indicate whether a given friend is an “in-game friend,” an “out-of-game friend,” or both. The various embodiments disclosed herein are operable when the social graph is managed by the application, a social networking system, or both.

### Example Systems and Methods

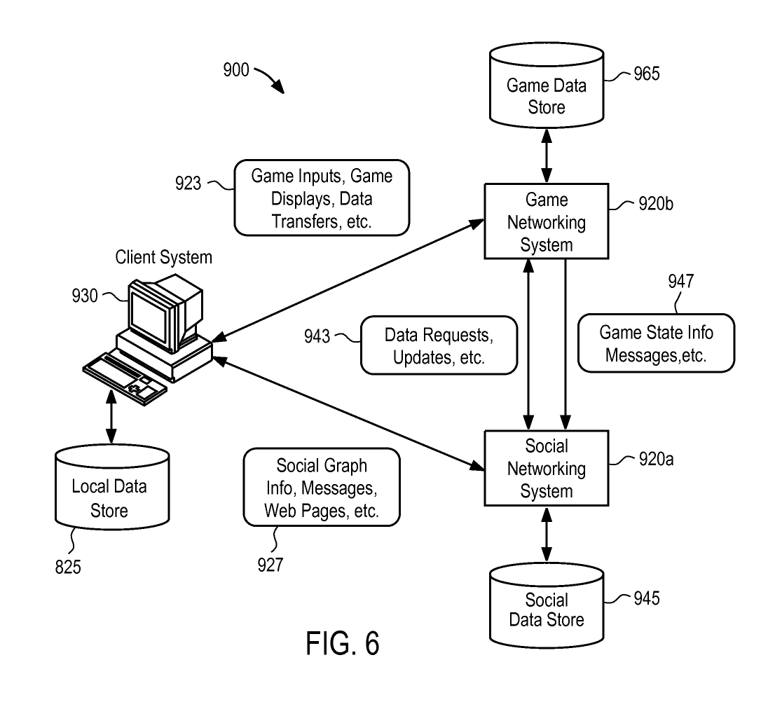

FIG. 6 illustrates an example data flow between example components of an example system 900, according to an example embodiment. One or more of the components of the example system 900 may correspond to one or more of the components of the example system 100. In some embodiments, system 900 includes a client system 930, a social networking system 920a, and a game networking system 920b. The components of system 900 can be connected to each other in any suitable configuration, using any suitable type of connection. The components may be connected directly or over any suitable network. The client system 930, the social networking system 920a, and the game networking system 920b may have one or more corresponding data stores such as the local data store 925, the social data store 945, and the game events store 965, respectively.

The client system 930 may receive and transmit data 923 to and from the game networking system 920b. This data can include, for example, a web page, a message, a game input, a game display, a HTTP packet, a data request, transaction information, and other suitable data. At some other time, or at the same time, the game networking system 920b may communicate data 943, 947 (e.g., game state information, game system account information, page info, messages, data requests, updates, etc.) with other networking systems, such as the social networking system 920a (e.g., Facebook, Myspace, etc.). The client system 930 can also receive and transmit data 927 to and from the social networking system 920a. This data can include, for example, web pages, messages, social graph information, social network displays, HTTP packets, data requests, transaction information, updates, and other suitable data.

Communication between the client system 930, the social networking system 920a, and the game networking system 920b can occur over any appropriate electronic communication medium or network using any suitable communications protocols. For example, the client system 930, as well as various servers of the systems described herein, may include Transport Control Protocol/Internet Protocol (TCP/IP) networking stacks to provide for datagram and transport functions. Of course, any other suitable network and transport layer protocols can be utilized.

In some embodiments, an instance of a virtual game is stored as a set of game state parameters that characterize the state of various in-game objects, such as, for example, player character state parameters, non-player character parameters, and virtual item parameters. In some embodiments, game state is maintained in a database as a serialized, unstructured string of text data as a so-called Binary Large Object (BLOB). When a user accesses a virtual game on the game networking system 920b, the BLOB containing the game state for the instance corresponding to the user may be transmitted to the client system 930 for use by a client-side executed object to process. In some embodiments, the client-side executable is a FLASH-based game, which can de-serialize the game state data in the BLOB. As a user plays the game, the game logic implemented at the client system 930 maintains and modifies the various game state parameters locally. The client-side game logic may also batch game events, such as mouse clicks, and transmit these events to the game networking system 920b. Game networking system 920b may itself operate by retrieving a copy of the BLOB from a database or an intermediate memory cache (memcache) layer. The game networking system 920b can also de-serialize the BLOB to resolve the game state parameters and execute its own game logic based on the events in the batch file of events transmitted by the client to synchronize the game state on the server side. The game networking system 920b may then re-serialize the game state, now modified into a BLOB, and pass this to a memory cache layer for lazy updates to a persistent database.

In some embodiments, a computer-implemented game is a text-based or turn-based game implemented as a series of web pages that are generated after a user selects one or more actions to perform. The web pages may be displayed in a browser client executed on the client system 930. For example, a client application downloaded to the client system 930 may operate to serve a set of web pages to a user. As another example, a virtual game may be an animated or rendered game executable as a stand-alone application or within the context of a webpage or other structured document. In some embodiments, the virtual game is implemented using Adobe Flash-based technologies. As an example, a game may be fully or partially implemented as a SWF object that is embedded in a web page and executable by a Flash media user plug-in. In some embodiments, one or more described web pages is associated with or accessed by the social networking system 920a. This disclosure contemplates using any suitable application for the retrieval and rendering of structured documents hosted by any suitable network-addressable resource or website.

Application event data of a game is any data relevant to the game (e.g., user inputs). In some embodiments, each application datum may have a name and a value, and the value of the application datum may change (e.g., be updated) at any time. When an update to an application datum occurs at the client system 930, either caused by an action of a game user or by the game logic itself, the client system 930 may need to inform the game networking system 920b of the update. For example, if the game is a farming game with a harvest mechanic (such as Zynga FarmVille), an event can correspond to a user clicking on a parcel of land to harvest a crop. In such an instance, the application event data may identify an event or action (e.g., harvest) and an object in the game to which the event or action applies.

In some embodiments, one or more objects of a game is represented as an Adobe Flash object. Flash may manipulate vector and raster graphics, and supports bidirectional streaming of audio and video. “Flash” may mean the authoring environment, the user, or the application files. In some embodiments, the client system 930 may include a Flash client. The Flash client may be configured to receive and run Flash application or game object code from any suitable networking system (such as, for example, the social networking system 920a or the game networking system 920b). In some embodiments, the Flash client is run in a browser client executed on the client system 930. A user can interact with Flash objects using the client system 930 and the Flash client. The Flash objects can represent a variety of in-game objects. Thus, the user may perform various in-game actions on various in-game objects by making various changes and updates to the associated Flash objects.

In some embodiments, in-game actions are initiated by clicking or similarly interacting with a Flash object that represents a particular in-game object. For example, a user can interact with a Flash object to use, move, rotate, delete, attack, shoot, or harvest an in-game object. This disclosure contemplates performing any suitable in-game action by interacting with any suitable Flash object. In some embodiments, when the user makes a change to a Flash object representing an in-game object, the client-executed game logic may update one or more game state parameters associated with the in-game object. To ensure synchronization between the Flash object shown to the user at the client system 930, the Flash client may send the events that caused the game state changes to the in-game object to the game networking system 920b. However, to expedite the processing and hence the speed of the overall gaming experience, the Flash client may collect a batch of some number of events or updates into a batch file. The number of events or updates may be determined by the Flash client dynamically or determined by the game networking system 920b based on server loads or other factors. For example, client system 930 may send a batch file to the game networking system 920b whenever 50 updates have been collected or after a threshold period of time, such as every minute.

As used herein, the term “application event data” may refer to any data relevant to a computer-implemented virtual game application that may affect one or more game state parameters, including, for example and without limitation, changes to user data or metadata, changes to user social connections or contacts, user inputs to the game, and events generated by the game logic. In some embodiments, each application datum has a name and a value. The value of an application datum may change at any time in response to the game play of a user or in response to the game engine (e.g., based on the game logic). In some embodiments, an application data update occurs when the value of a specific application datum is changed.

In some embodiments, when a user plays a virtual game on the client system 930, the game networking system 920b serializes all the game-related data, including, for example and without limitation, game states, game events, user inputs, for this particular user and this particular game into a BLOB and may store the BLOB in a database. The BLOB may be associated with an identifier that indicates that the BLOB contains the serialized game-related data for a particular user and a particular virtual game. In some embodiments, while a user is not playing the virtual game, the corresponding BLOB may be stored in the database. This enables a user to stop playing the game at any time without losing the current state of the game the user is in. When a user resumes playing the game next time, game networking system 920b may retrieve the corresponding BLOB from the database to determine the most-recent values of the game-related data. In some embodiments, while a user is playing the virtual game, the game networking system 920b also loads the corresponding BLOB into a memory cache so that the game system may have faster access to the BLOB and the game-related data contained therein.

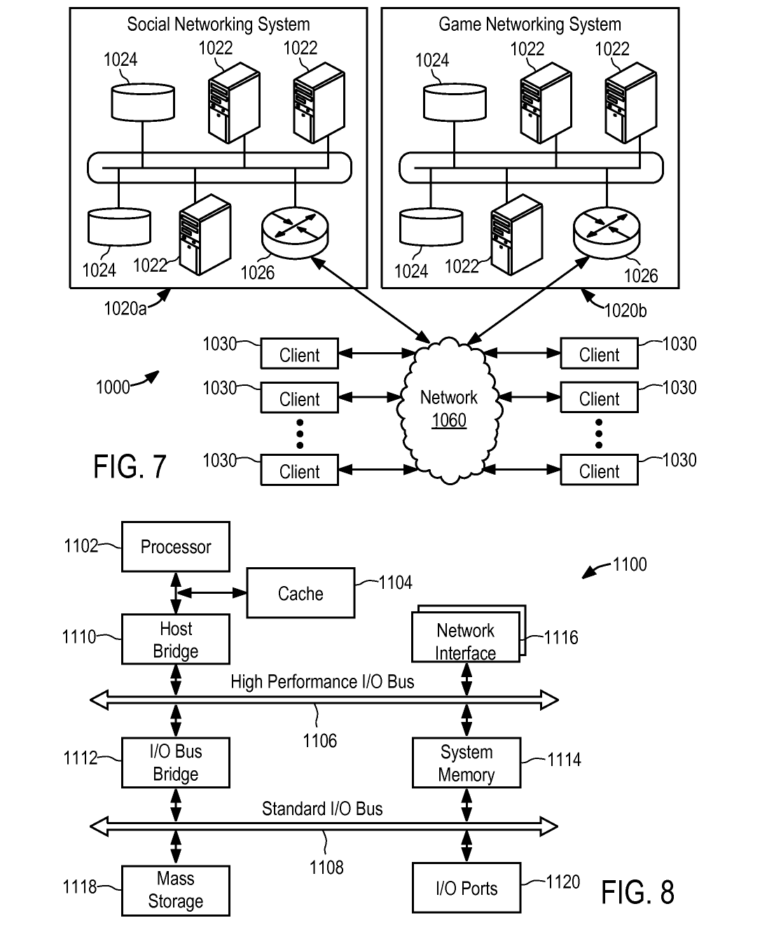

Various embodiments may operate in a wide area network environment, such as the Internet, including multiple network addressable systems. FIG. 7 illustrates an example network environment 1000, in which various example embodiments may operate. Network cloud 1060 generally represents one or more interconnected networks, over which the systems and hosts described herein can communicate. Network cloud 1060 may include packet-based wide area networks (such as the Internet), private networks, wireless networks, satellite networks, cellular networks, paging networks, and the like. As FIG. 7 illustrates, various embodiments may operate in a network environment 1000 comprising one or more networking systems, such as a social networking system 1020a, a game networking system 1020b, and one or more client systems 1030. The components of the social networking system 1020a and the game networking system 1020b operate analogously; as such, hereinafter they may be referred to simply as the networking system 1020. The client systems 1030 are operably connected to the network environment 1000 via a network service provider, a wireless carrier, or any other suitable means.

The networking system 1020 is a network addressable system that, in various example embodiments, comprises one or more physical servers 1022 and data stores 1024. The one or more physical servers 1022 are operably connected to computer network cloud 1060 via, by way of example, a set of routers and/or networking switches 1026. In an example embodiment, the functionality hosted by the one or more physical servers 1022 may include web or HTTP servers, FTP servers, as well as, without limitation, webpages and applications implemented using Common Gateway Interface (CGI) script, PHP Hyper-text Preprocessor (PHP), Active Server Pages (ASP), Hyper-Text Markup Language (HTML), Extensible Markup Language (XML), Java, JavaScript, Asynchronous JavaScript and XML (AJAX), Flash, ActionScript, and the like.

The physical servers 1022 may host functionality directed to the operations of the networking system 1020. Hereinafter servers 1022 may be referred to as server 1022, although the server 1022 may include numerous servers hosting, for example, the networking system 1020, as well as other content distribution servers, data stores, and databases. Data store 1024 may store content and data relating to, and enabling, operation of, the networking system 1020 as digital data objects. A data object, in some embodiments, is an item of digital information typically stored or embodied in a data file, database, or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, etc.

Logically, data store 1024 corresponds to one or more of a variety of separate and integrated databases, such as relational databases and object-oriented databases, that maintain information as an integrated collection of logically related records or files stored on one or more physical systems. Structurally, data store 1024 may generally include one or more of a large class of data storage and management systems. In some embodiments, data store 1024 may be implemented by any suitable physical system(s) including components, such as one or more database servers, mass storage media, media library systems, storage area networks, data storage clouds, and the like. In one example embodiment, data store 1024 includes one or more servers, databases (e.g., MySQL), and/or data warehouses. Data store 1024 may include data associated with different networking system 1020 users and/or client systems 1030.

The client system 1030 is generally a computer or computing device including functionality for communicating (e.g., remotely) over a computer network. The client system 1030 may be a desktop computer, laptop computer, personal digital assistant (PDA), in- or out-of-car navigation system, smart phone or other cellular or mobile phone, or mobile gaming device, among other suitable computing devices. Client system 1030 may execute one or more client applications, such as a Web browser.

When a user at a client system 1030 desires to view a particular webpage (hereinafter also referred to as target structured document) hosted by the networking system 1020, the user's web browser, or other document rendering engine or suitable client application, formulates and transmits a request to the networking system 1020. The request generally includes a URL or other document identifier as well as metadata or other information. By way of example, the request may include information identifying the user, a timestamp identifying when the request was transmitted, and/or location information identifying a geographic location of the user's client system 1030 or a logical network location of the user's client system 1030.

Although the example network environment 1000 described above and illustrated in FIG. 7 is described with respect to the social networking system 1020a and the game networking system 1020b, this disclosure encompasses any suitable network environment using any suitable systems. For example, a network environment may include online media systems, online reviewing systems, online search engines, online advertising systems, or any combination of two or more such systems.

FIG. 8 is illustrates an example computing system architecture, which may be used to implement a server 1022 or a client system 1030. In one embodiment, the hardware system 1100 comprises a processor 1102, a cache memory 1104, and one or more executable modules and drivers, stored on storage device, directed to the functions described herein. Additionally, the hardware system 1100 may include a high performance input/output (I/O) bus 1106 and a standard I/O bus 1108. A host bridge 1110 may couple the processor 1102 to the high performance I/O bus 1106, whereas the I/O bus bridge 1112 couples the two buses 1106 and 1108 to each other. A system memory 1114 and one or more network/communication interfaces 1116 may couple to the bus 1106. The hardware system 1100 may further include video memory (not shown) and a display device coupled to the video memory. Mass storage 1118 and I/O ports 1120 may couple to the bus 1108. The hardware system 1100 may optionally include a keyboard, a pointing device, and a display device (not shown) coupled to the bus 1108. Collectively, these elements are intended to represent a broad category of computer hardware systems.

The elements of the hardware system 1100 are described in greater detail below. In particular, the network interface 1116 provides communication between the hardware system 1100 and any of a wide range of networks, such as an Ethernet (e.g., IEEE 802.3) network, a backplane, etc. The mass storage 1118 provides permanent storage for the data and programming instructions to perform the above-described functions implemented in servers 1022 of FIG. 7, whereas system memory 1114 (e.g., DRAM) provides temporary storage for the data and programming instructions when executed by the processor 1102. I/O ports 1120 are one or more serial and/or parallel communication ports that provide communication between additional peripheral devices, which may be coupled to the hardware system 1100.

The hardware system 1100 may include a variety of system architectures and various components of the hardware system 1100 may be rearranged. For example, cache memory 1104 may be on-chip with the processor 1102. Alternatively, the cache memory 1104 and the processor 1102 may be packed together as a “processor module,” with processor 1102 being referred to as the “processor core.” Furthermore, certain embodiments of the present disclosure may neither require nor include all of the above components. For example, the peripheral devices shown coupled to the standard I/O bus 1108 may couple to the high performance I/O bus 1106. In addition, in some embodiments, only a single bus may exist, with the components of the hardware system 1100 being coupled to the single bus. Furthermore, the hardware system 1100 may include additional components, such as additional processors, storage devices, or memories.

An operating system manages and controls the operation of the hardware system 1100, including the input and output of data to and from software applications (not shown). The operating system provides an interface between the software applications being executed on the system and the hardware components of the system. Any suitable operating system may be used.

Furthermore, the above-described elements and operations may comprise instructions that are stored on non-transitory storage media. The instructions can be retrieved and executed by a processing system. Some examples of instructions are software, program code, and firmware. Some examples of non-transitory storage media are memory devices, tape, disks, integrated circuits, and servers. The instructions may be executed by the processing system to direct the processing system to operate in accord with the disclosure. The term “processing system” refers to a single processing device or a group of inter-operational processing devices. Some examples of processing devices are integrated circuits and logic circuitry. Those skilled in the art are familiar with instructions, computers, and storage media.

One or more features from any embodiment may be combined with one or more features of any other embodiment without departing from the scope of the disclosure.

A recitation of “a”, “an,” or “the” is intended to mean “one or more” unless specifically indicated to the contrary. In addition, it is to be understood that functional operations, such as “awarding”, “locating”, “permitting” and the like, are executed by game application logic that accesses, and/or causes changes to, various data attribute values maintained in a database or other memory.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

For example, the methods, game features and game mechanics described herein may be implemented using hardware components, software components, and/or any combination thereof. By way of example, while embodiments of the present disclosure have been described as operating in connection with a networking website, various embodiments of the present disclosure can be used in connection with any communications facility that supports web applications. Furthermore, in some embodiments the term “web service” and “website” may be used interchangeably and additionally may refer to a custom or generalized API on a device, such as a mobile device (e.g., cellular phone, smart phone, personal GPS, personal digital assistance, personal gaming device, etc.), that makes API calls directly to a server. Still further, while the embodiments described above operate with business-related virtual objects (such as stores and restaurants), the embodiments can be applied to any in-game asset around which a harvest mechanic is implemented, such as a virtual stove, a plot of land, and the like. The specification and drawings are, accordingly, to be regarded in an illustrative rather than a restrictive sense. It will, however, be evident that various modifications and changes may be made thereunto without departing from the broader spirit and scope of the disclosure as set forth in the claims and that the disclosure is intended to cover all modifications and equivalents within the scope of the following claims.

What is claimed is:

1. A computer-implemented method of tracking resource consumption for an invitee within a cloud system, the cloud system including a first computational resource and a second computational resource, the method comprising:
accessing a first aggregated nodal log maintained by the first computational resource, the first aggregated nodal log including a first invitee usage record that specifies first usage data characterizing consumption from the first computational resource by the invitee;
accessing a second aggregated nodal log maintained by the second computational resource, the second aggregated nodal log including a second invitee usage record that specifies second usage data characterizing consumption from the second computational resource by the invitee;
determining, by one or more processors, the resource consumption of resources within the cloud system by the invitee, the determining comprising combining the first usage data of the first invitee usage record with the second usage data of the second invitee usage record; and
performing a corrective action within the cloud system based on the resource consumption.

2. The computer-implemented method of claim 1, wherein the first computational resource and the second computational resource each provides a service for a game hosted by the cloud system.

3. The computer-implemented method of claim 2, wherein the invitee corresponds to a user account created by the game hosted by the cloud system for use with the game.

4. The computer-implemented method of claim 1, wherein the corrective action includes limiting access for the invitee to the cloud system.

5. The computer-implemented method of claim 1, wherein performing the corrective action based on the resource consumption includes determining that a frequency associated with the resource consumption exceeds a threshold, the corrective action includes marking an account associated with the invitee as a potential bot.

6. The computer-implemented method of claim 1, wherein the usage data represents at least one of: a processing bandwidth, memory usage, a thread count, a number of requests, or a type of service.

7. The computer-implemented method of claim 1, wherein the resource consumption measures a measurement of a type of service being requested, and performing the corrective action includes determining that the measurement of the type of service being requested exceeds a threshold, and the corrective action includes marking an account associated with the invitee as a potential fraudster.

8. A computer-implemented system of tracking resource consumption for an invitee within a cloud system, the cloud system including a first computational resource and a second computational resource, the system comprising:
a usage monitor implemented by one or more processors and configured to:
access a first aggregated nodal log maintained by the first computational resource, the first aggregated nodal log including a first invitee usage record that specifies first usage data characterizing consumption from the first computational resource by the invitee;
access a second aggregated nodal log maintained by the second computational resource, the second aggregated nodal log including a second invitee usage record that specifies second usage data characterizing consumption from the second computational resource by the invitee;
determine the resource consumption of resources within the cloud system by the invitee, the determining comprising combining, by a cloud usage module, the first usage data of the first invitee usage record with the second usage data of the second invitee usage record; and
perform a corrective action within the cloud system based on the resource consumption.

9. The computer-implemented system of claim 8, wherein the first computational resource and the second computational resource each provides a service for a game hosted by the cloud system.

10. The computer-implemented system of claim 9, wherein the invitee corresponds to a user account created by the game hosted by the cloud system for use with the game.

11. The computer-implemented system of claim 8, wherein the corrective action includes limiting access for the invitee to the cloud system.

12. The computer-implemented system of claim 8, wherein performing the corrective action based on the resource consumption includes determining that a frequency associated with the resource consumption exceeds a threshold, the corrective action includes marking an account associated with the invitee as a potential bot.

13. The computer-implemented system of claim 8, wherein the usage data represents at least one of: a processing bandwidth, memory usage, a thread count, a number of requests, or a type of service.

14. The computer-implemented system of claim 8, wherein the resource consumption measures a measurement of a type of service being requested, and performing the corrective action includes determining that the measurement of the type of service being requested exceeds a threshold, and the corrective action includes marking an account associated with the invitee as a potential fraudster.

15. A storage device storing executable instructions thereon, which, when executed by a processor, cause the processor to perform operations comprising:
accessing a first aggregated nodal log maintained by the first computational resource, the first aggregated nodal log including a first invitee usage record that specifies first usage data characterizing consumption from the first computational resource by the invitee;
accessing a second aggregated nodal log maintained by the second computational resource, the second aggregated nodal log including a second invitee usage record that specifies second usage data characterizing consumption from the second computational resource by the invitee;
determining the resource consumption of resources within the cloud system by the invitee, the determining comprising combining, by a cloud usage module, the first usage data of the first invitee usage record with the second usage data of the second invitee usage record; and
performing a corrective action within the cloud system based on the resource consumption.

16. The storage device of claim 15, wherein the first computational resource and the second computational resource each provides a service for a game hosted by the cloud system.

17. The storage device of claim 16, wherein the invitee corresponds to a user account created by the game hosted by the cloud system for use with the game.

18. The storage device of claim 15, wherein the corrective action includes limiting access for the invitee to the cloud system.

19. The storage device of claim 15, wherein performing the corrective action based on the resource consumption includes determining that a frequency associated with the resource consumption exceeds a threshold, the corrective action includes marking an account associated with the invitee as a potential bot.

20. The storage device of claim 15, wherein the usage data represents at least one of: a processing bandwidth, memory usage, a thread count, a number of requests, or a type of service.
